(19) United States
(12) Patent Application Publication
(10) Pub. No.: US 2026/0368365 A1
(43) Pub. Date: Nov. 19, 2026

(54) METHOD OF OBTAINING A SECURE COMPUTER PROGRAM BUNDLE BY A PASSENGER TRANSPORT INSTALLATION, COMPUTER-READABLE PROGRAM PRODUCT FOR UPDATING A SAFETY NODE OF A PASSENGER TRANSPORT INSTALLATION, PASSENGER TRANSPORT INSTALLATION AND SOFTWARE DEPLOYMENT SYSTEM

(71) Applicant: Inventio AG, Hergiswil (CH)

(72) Inventors: Valerio Villa, Colverde (IT); Gianpiero Guerra, Cannobio (IT); Peter Robert Egli, Männedorf (CH)

(21) Appl. No.: 19/138,735

(22) PCT Filed: Dec. 11, 2023
(86) PCT No.: PCT/EP2023/085134

§ 371 Date: Jun. 13, 2025

(30) Foreign Application Priority Data
Dec. 22, 2022 (EP) 22215744.6

(51) Int. Cl. G06F 21/64; H04L 9/08; H04L 9/30; H04L 9/32

(52) U.S. Cl. CPC G06F 21/64; H04L 9/0825; H04L 9/30; H04L 9/3236; H04L 9/3247; H04L 9/3271

(57) ABSTRACT

A method of obtaining a secure computer program bundle by a passenger transport installation includes obtaining a computer-readable program product, the computer-readable program product including the secure computer program bundle, a review package, and a deployment package. The method can include obtaining and/or verifying a public deployment key and a public review key. A deployment signature of the deployment package is verified with the public deployment key and a review signature of the review package is verified with the public review key.

### FIELD

The present invention relates to the improved deployment of software to be executed on components of passenger transport installations, particularly safety-related components, such as safety nodes. The methods, products and systems described herein particularly include generating a computer-readable program product. Embodiments of the computer-readable program products include a deployment package, a review authority package, a developer package and a computer program bundle. Some embodiments include verifying a deployment signature, a review authority signature, and a developer signature with public keys, and the computer program bundle with a device secret.

### BACKGROUND

Passenger transport installations, such as elevators, escalators or moving walkways, are known in the art. Such passenger transport installations often include node devices (“nodes”) related to the control, sensing and monitoring of the passenger transport installation. In cases where the nodes provide safety-related functionality, such as monitoring or controlling safety-related functions or parameters of the passenger transport installation, the node may be classified as a safety node. For example, safety nodes of an elevator installation may include, but are not limited to, landing door nodes, car door nodes, and/or car nodes, and/or subsystems thereof.

A safety node may include hardware, such as a processor and a memory, for executing a safety-related software controlling functions of the safety node. Accordingly, such safety-related software is typically related to the overall safety of the passenger transport installation and must conform to high standards that may include reviewing the software by a review authority. The execution of faulty or malicious safety-related software may result in an unsafe passenger transport installation and is generally undesirable.

Known passenger transport installations may not provide means for updating the safety-related software of a safety node remotely. For example, updating a safety-related software of a safety node may require physically accessing the safety node by a skilled technician to insert or replace a memory device, or even replacing the safety node.

### SUMMARY

Thus, there is a need to improve the updating of safety-related software of safety nodes of passenger transport installations. The methods, products and systems described herein solve the above-stated problem at least in part.

The invention is set out in the following aspects and detailed description.

According to an aspect, a method of obtaining a secure computer program bundle by a passenger transport installation is described. The method includes obtaining a computer-readable program product. The computer-readable program product includes the computer program bundle, a review package, and a deployment package. The method may optionally include obtaining and/or verifying a public deployment key and a public review key. The method includes verifying a deployment signature of the deployment package with the public deployment key, and verifying a review signature of the review package with the public review key.

According to an aspect, a method of obtaining a secure computer program bundle by a passenger transport installation is described. The method includes obtaining a computer-readable program product. The computer-readable program product includes the computer program bundle, a developer package, a review authority package, and optionally a deployment package. The method may optionally include obtaining and/or verifying a public deployment key, a public review authority key and a public developer key. The method may include optionally verifying a deployment signature of the deployment package with the public deployment key. The method includes verifying a review authority signature of the review authority package with the public review authority key and verifying a developer signature of the developer package with the public developer key. The method may further include optionally verifying the computer program bundle with a device secret.

According to an aspect, a computer-readable program product for updating a safety node of a passenger transport installation is described. The computer-readable program product includes a deployment package. The deployment package includes data including a review package, and a deployment signature of the review package generated with an asymmetric private deployment key. The review package includes a review signature of data including a computer program bundle generated with an asymmetric private review authority key, and the computer program bundle. The computer program bundle includes a safety node computer program executable by the safety node of the passenger transport installation. The computer-readable program product optionally includes a challenge hash generated from data comprising the safety node computer program and a developer secret. The computer-readable program product is receivable by a communication device of the passenger transport installation, particularly a node device and/or an edge device. The authenticity of the deployment package is verifiable by the communication device of the passenger transport installation using a public deployment key corresponding to the private deployment key. The authenticity of the review package is verifiable by the communication device of the passenger transport installation using a public review key corresponding to the private review key.

According to an aspect, a computer-readable program product for updating a safety node of a passenger transport installation is described. The computer-readable program product includes a deployment package. The deployment package includes data including a review authority package, and a deployment signature of the review authority package generated with an asymmetric private deployment key. The review authority package includes data including a developer package, and a review authority signature of the developer package generated with an asymmetric private review authority key. The developer package includes data including a computer program bundle, and a developer signature of the computer program bundle generated with an asymmetric private developer key. The computer program bundle includes a safety node computer program executable by the safety node of the passenger transport installation. The computer-readable program product optionally includes a challenge hash generated from data comprising the safety node computer program and a developer secret. The computer-readable program product is receivable by a communication device of the passenger transport installation, particularly a node device and/or an edge device. The authenticity of the deployment package is verifiable by the communication device of the passenger transport installation using a public deployment key corresponding to the private deployment key. The authenticity of the review authority package is verifiable by the communication device of the passenger transport installation using a public review authority key corresponding to the private review authority key. The authenticity of the developer package is verifiable by the communication device of the passenger transport installation using a public developer key corresponding to the private developer key. The authenticity of the safety node computer program may optionally be verifiable by the safety node of the passenger transport installation using a device secret corresponding to the developer secret.

According to an aspect, a software deployment system is described. The software deployment system includes, on a data storage device, a computer-readable program product according to aspects and/or embodiments described herein.

According to an aspect, a passenger transport installation is described. The passenger transport installation may be an elevator, such as a passenger elevator. The passenger transport installation may be an escalator or a moving walkway. The passenger transport installation may be an installation provided on or within a structure, such as a building, a ship, a crane, or any other type of structure, such as a cavern or a mine. The installation may be fixedly provided on or within the structure. Vehicles, such as aircraft, watercraft or ground vehicles such as cars, trains or the like are not considered passenger transport installations.

According to an aspect, a computer program bundle is described. The computer program bundle may be a secure computer program bundle. Secure, in the context of this disclosure, may include the computer program bundle to be authenticated and/or authenticatable by the passenger transport installation. Secure, in the context of this disclosure, may further include the computer program bundle, or a software included in the computer program bundle, to be suitable for being safely executed on a safety related component, such as a safety node, of the passenger transport installation. A computer program bundle according to embodiments of this disclosure may be a secure computer program bundle. A passenger transport installation according to embodiments may be configured for receiving, identifying as authentic and/or installing a secure computer program bundle. A software deployment system according to embodiments may be configured for deploying a secure computer program bundle.

According to an aspect, the use of public keys for verifying signatures is described. In particular, a public deployment key for verifying a deployment package, a public review authority key for verifying a review authority package, a public review key for verifying a review package, and a public developer key for verifying a developer package are described. The use of public keys, signatures and private keys may relate to the employment of asymmetric cryptography, public key cryptography and/or asymmetric encryption, e.g. according to methods and/or algorithms known in the art. Suitable algorithms may include RSA, Elliptic Curve Cryptography (ECC), El Gamal and/or DSA, and/or the use thereof. Accordingly, signatures, in the context of this disclosure, may be understood as digital signatures.

Still pertaining to this aspect, embodiments of the present disclosure may include the generation of a digital signature of a data package with a private key, and may further include the verification of the digital signature with a public key corresponding to the private key. While embodiments of the present disclosure are described as utilizing digital signatures, which may include the transmission of unencrypted data signed with the digital signature, encrypting the data with a private key and decrypting the data with a corresponding public key may likewise be considered as verifying a digital signature, and should be considered as falling within the scope of this disclosure. Furthermore, according to embodiments, the term “public key” in the context of this disclosure does not necessarily include a wide-spread distribution or even publication of the public key. For example, the methods and systems described herein may utilize a public key infrastructure (PKI) for transmitting the public keys to a communication device of the passenger transport installation, such as a PKI known to the skilled person at the time of filing of this disclosure, and the PKI may be inaccessible to the public, e.g. by forming part of, or being at least partially implemented as, a secured network. In a yet further example, the devices described herein, such as the edge device, the node device and/or the safety node, may be provided with static public keys stored therein, i.e. the public keys may not require being transmitted with a PKI, and thus be considered secret public keys.

According to an aspect, the verification of a computer program bundle with a device secret is described. The verification of the computer program bundle may include a verification of essentially the complete computer program bundle, or only a portion of the computer program bundle, such as one or more data packages and/or safety node computer programs included in the computer program bundle. For example, the computer program bundle may include safety node computer programs, executables, libraries, and/or data packages such as firmwares, and the verification of the computer program bundle may include verifying the data to be utilized after verification, e.g. the one or more executables, libraries and/or data packages to be installed on a safety node.

According to an aspect, the verification of the computer program bundle includes a hashing operation, and particularly includes performing a cryptographic hash function. According to embodiments, data included, e.g. in the computer program bundle, is created by a developer and hashed with the cryptographic hash function together with a developer secret known to the developer and stored, as a device secret known e.g. to the manufacturer of the safety node, in a memory of a safety node. The data and the device secret or developer secret may be processed, in the hashing operation, according to predefined rules known to both the developer and the safety node, for example, the data may form a first data block, and the device secret or developer secret may be a second data block following the first data block. The hashing operation may be performed in the same manner, e.g. according to the predefined rules, by a safety node after receiving the data. The resulting hash may be indicative of an authenticity of the data and the device secret, e.g. provided that the hash generated by the developer is identical to the hash generated by the safety node, it may be assumed that the data is authentic. The hashing operation may include a known hash function, such as a SHA-2 hash function, such as SHA-256, SHA-384, SHA-512, and variations thereof, such as triple SHA-256. Other types of hash functions, such as BLAKE, GOST, HAVAL, MD5, MD6, RIPEMD, SHA-3, Streebog, Tiger, Whirlpool, and/or combinations or variations thereof, may be equally suitable.

According to an aspect, a computer-readable program product is described. The computer-readable program product may be a computer-readable program product, a computer-readable data product, or a combination thereof. The computer-readable program product may include data including and/or encoding at least one computer program executable and/or suitable for being compiled to be executed on a processor, particularly on a processor of a safety node according to embodiments described herein. The computer-readable program product may be a data structure including yet further data structures. The computer-readable program product may include a review package and a deployment package and a computer program bundle. The computer-readable program product may include a developer package and a review authority package and a computer program bundle. The computer-readable program product may include a deployment package, a review authority package, a developer package and a computer program bundle. The deployment package may include the review package. The deployment package may include the review authority package. The review package may include the computer program bundle. The review authority package may include the developer package. The developer package may include the computer program bundle. The computer program bundle may include the at least one computer program, such as a safety node computer program.

Still pertaining to this aspect, one or more first packages as described herein may be included, particularly in combination with yet further data, in a second package as described herein, e.g. as unmodified data, as compressed data, as encoded data, as encrypted data or any other type of data that may allow the reconstruction of the one or more first packages from the second package.

### DESCRIPTION OF THE DRAWINGS

The details will be described in the following with reference to the figures, wherein:

FIG. 1 is a schematic view of a node including a safety node of a passenger transport installation according to embodiments;

FIG. 2A is a schematic representation of a computer-readable program product according to embodiments;

FIG. 2B is a schematic representation of a computer-readable program product according to embodiments;

FIG. 2C is a schematic representation of a computer-readable program product according to embodiments;

FIG. 3A is a schematic flowchart showing a method of generating a computer-readable program product according to embodiments;

FIG. 3B is a schematic flowchart showing a method of generating a computer-readable program product according to embodiments; and

FIG. 4 is a schematic flowchart showing a method of obtaining a secure computer program bundle by a passenger transport installation according to embodiments.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment applies to a corresponding part or aspect in another embodiment as well.

It should be noted that the systems according to embodiments described herein may be suitable for executing methods according to embodiments described herein, and products according to embodiments described herein may be suitable to be used with methods and/or by systems according to embodiments described herein. Accordingly, in the following description of embodiments, aspects of e.g. a computer-readable program product may be explained in combination with the method utilizing the computer-readable program product and/or the system suitable for performing the method, and vice versa.

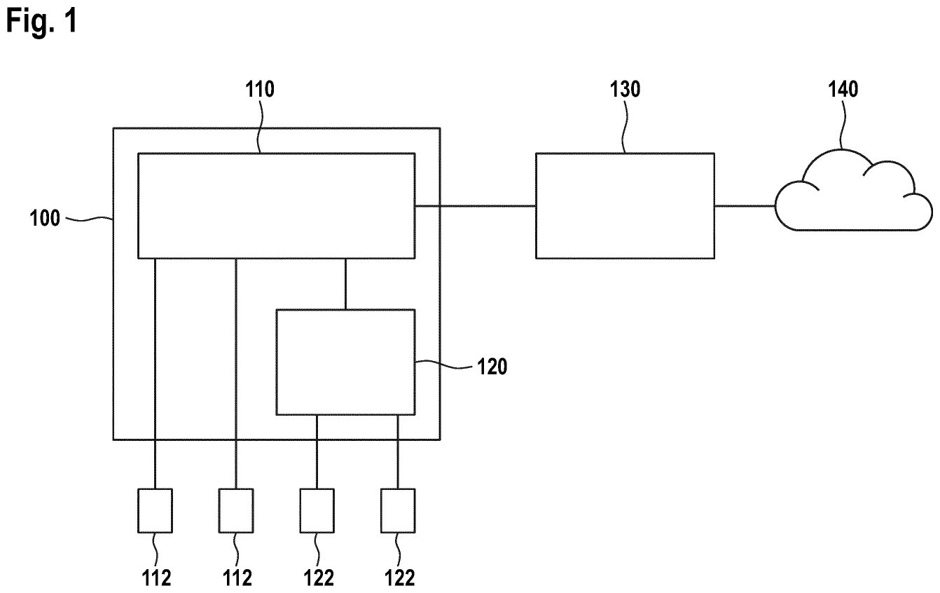

Referring now to FIG. 1, a schematic representation of a node device 100 according to embodiments is shown. The node device 100 may be included in a passenger transport installation, and/or be a node device 100 of a passenger transport installation. The node device 100 may be a controller and/or control unit of the passenger transport installation. The node device 100 may be configured for controlling, monitoring, scheduling and/or sensing safety-related functions of the passenger transport installation. Examples of node devices 100 include, but are not limited to, node devices of elevator systems, such as landing door nodes, car door nodes and/or car nodes.

The node device 100 includes a first processor 110 and a safety node 120. As shown in FIG. 1, the safety node 120 may be included in a node device 100, and particularly be a subsystem of the node device 100. Alternatively, the safety node 120 may be a device separate from the node device 100, i.e. a separate safety node. A separate safety node 120 may be substantially identical to the node device 100 described herein. A separate safety node 120 may be configured for performing safety-related tasks, e.g. by not being connected to non-safety related external devices 112. The safety node 120 may include a second processor (not shown). The first processor 110 may be connected to a first memory (not shown), and the second processor may be communicatively connected to second memory (not shown). For a separate safety node, the first processor 110 and the first memory may be optional.

The first processor 110 may be configured for executing a first software. The first software may be stored in the first memory. The first software may be configured for performing functions related to non-safety related tasks of the node device 100. For example, one or more external devices 112 may be communicatively connected to the first processor 110. The external devices 112 may be sensors. The external devices 112 may be devices controllable by the node device 100, particularly the first processor 110. In particular, the sensors and/or external devices 112 may be related to non-safety related functions of the elevator installation.

The second processor included in the safety node 120 may be configured for executing a second software, such as a safety node computer program. The second software may be stored in the second memory. The second software may be configured for performing functions related to safety related tasks of the node device 100. For example, one or more external devices 122 may be communicatively connected to the second processor included in the safety node 120. The external devices 122 may be sensors. The external devices 122 may be devices controllable by the node device 100, particularly the safety node 120. In particular, the sensors and/or external devices 122 may be related to safety related functions of the elevator installation.

According to embodiments, the node device 100 may be a landing door node. The landing door node may be a controller for controlling, monitoring, scheduling and/or sensing functions and/or parameters of an elevator landing door. For example, the non-safety related external devices 112 may include landing indicator panels, landing operating panels, shaft lights, and/or motors associated with the landing door. For example, the safety-related external devices 122 may include a landing door lock sensor and/or actuator, and/or a door sensor, such as a reed contact sensor.

According to embodiments, the node device 100 may be a first node device. The first node device may, for example, be a door node or a car control unit. The first node device may be communicatively connected to a second node device. The second node device may be a node device similar or identical to the node device 100. The first node device may be indirectly communicatively connected to an edge device 130 through the second node device. For example, a door node may be communicatively connected to a car control node, and the car control node may be communicatively connected to the edge device 130. In the example, the door node may communicate with the edge device through the car control unit.

It is also possible to have several landing door nodes at a single landing. In such a case, several of the above named functions are distributed to the several landing door nodes.

According to embodiments, the node device 100 may be a car door node. The car door node may be a controller for controlling, monitoring, scheduling and/or sensing functions and/or parameters of an elevator car door. For example, the non-safety related external devices 112 may include shaft lights, motors associated with the elevator car door, and/or a passenger presence detector, such as a scanner, such as a 2D scanner. The safety-related external devices 122 may include a car door lock sensor and/or actuator, and/or a door sensor, such as a reed contact sensors.

According to embodiments, the node device 100 may be a car node. The car node may be a controller for controlling, monitoring, scheduling and/or sensing functions and/or parameters of an elevator car. For example, the non-safety related external devices 112 may include a car operating panel, a car top horn, a car buzzer, car LEDs and/or the car light. For example, the safety-related external devices 122 may include a balustrade sensor, a car top stop button, a slack sensor, a load sensor, an accelerometer, a position sensor such as a laser position sensor, a brake sensor, a brake switch and/or a brake controller.

It is also possible to have several car nodes on a single car. In such a case, several of the above named functions are distributed to the several car nodes.

According to embodiments, the safety-related external devices 122 may be components of other nodes, controllers and/or monitoring systems of the elevator installation, e.g. a safety-related external device 122 may include a trigger for triggering a system-wide STOP signal, and/or a mode switch or mode selector for selecting a drive mode of the elevator drive.

According to embodiments, as shown in FIG. 1, the safety node 120 may be communicatively connected to the first processor 110. Accordingly, signals and/or data received from or sent to the external devices 112 may be communicated to the safety node 120 via the first processor 110. Likewise, data received, by the first processor 110, may be transferred from the first processor 110 to the safety node 120. In particular, an external device 112 may be both a non-safety related device, and a safety-related device. For example, a sensor signal may be evaluated by both the first processor 110 for a non-safety related function, and be evaluated by the safety node 120, additionally or alternatively, for a safety-related function. Likewise, a device may be operated in a normal operation mode by the first processor 110, and may be operated, e.g. during a safety-related operation mode, by the safety node 120.

As shown in FIG. 1, according to embodiments, the node device 100 may be communicatively connected to an edge device 130. The communicative connection between the edge device 130 and the node device 100 may include a communicative connection between the edge device 130 and the first processor 110. The communicative connection may be implemented as a data network, such as a local data network, such as a local area network (LAN) communicatively connecting devices of the passenger transport installation. The edge device 130 may be included in the passenger transport installation. The edge device 130 may be communicatively connected to a data network 140, such as a wide area data network, such as the internet. The edge device 130 may be configured for receiving data from the data network 140, and may further be configured for forwarding data to the node device 100. The edge device 130 may include a communication device. The edge device 130 may include a gateway device, such as an internet gateway device. The edge device 130 may include a router, such as a data packet router suitable for routing data packets sent to or received from the internet, such as TCP/IP or UDP packets. Accordingly, the edge device may include a processor, a memory, a firewall implemented either as a hardware or a software firewall, and/or at least one modem configured for connecting the edge device 130 to the data network 140.

According to embodiments, the edge device 130 may be communicatively connected to a deployment system, e.g. via the data network 140, for obtaining a computer-readable program product from the deployment system. The edge device 130 may be configured for receiving the computer-readable program product, either automatically, e.g. by connecting to the deployment system at regular intervals and downloading an available computer-readable program product, or in response to receiving a control signal causing the edge device 130 to download an available computer-readable program product.

According to embodiments, the edge device 130 may be configured for verifying a deployment signature included in the computer-readable program product, such as a deployment signature included in a deployment package, the deployment package being included in the computer-readable program product. Accordingly, the edge device 130 may be configured for receiving a public deployment key suitable for verifying the deployment signature, e.g. by receiving the public deployment key from a PKI.

According to embodiments, the edge device 130 is configured for transferring data included in the computer-readable program product to the node device. The data may be transferred only under the proviso that a verification of the deployment signature resulted in verifying the authenticity of e.g. a deployment package and/or a review package included in the computer-readable program product. The data may include e.g. a package included in the deployment package and/or the review package. The data included in the deployment package may include e.g. a review authority package. The data included in the deployment package may include e.g. a review package. In some embodiments, the data may be derived, from the computer-readable program product and/or the deployment package, e.g. by extracting, decrypting, unpacking or otherwise transforming the data from the computer-readable program product.

According to embodiments, the node device 100 is configured for obtaining the data transferred from the edge device 130. According to embodiments, the data may be transferred indirectly, e.g. through an interconnected node device, such as a second node device. The node device 100 is configured for verifying a review authority signature and a developer signature included in the data received from the edge device, such as data included in the deployment package and/or data included in the review package. In particular, the deployment package may include a review authority package with a signature verifiable with a public review authority key, and a developer package having a developer signature verifiable with a public developer key. In particular, the deployment package may include a review package with a signature verifiable with a public review key. In particular, the data may include the review package. Accordingly, the edge device 130 may be configured for receiving and/or transferring, to the node device 100, a public developer key suitable for verifying the developer signature of a developer package, and/or a public review authority key suitable for verifying the review authority signature of a review authority package, e.g. by receiving the public developer key, the public review key, and/or the public review authority key from a PKI.

According to embodiments, additionally, or alternatively, the edge device 130 may be configured for verifying the developer signature of the developer package, the review authority signature and/or the review signature of a review authority package, as described for the node device 100. Accordingly, the node device 100 verifying the review signature, the review authority signature and/or the deployment signature may include the node device 100 receiving the verified data from the edge device 130 after the edge device has verified the signatures. Accordingly, the node device 100 may be configured for verifying the review signature, the review authority signature and/or the deployment signature by being communicatively connected to an edge device 130 suitable for verifying the review authority signature and/or the deployment signature.

According to embodiments, the node device 100 is configured for transferring a computer program bundle included in the data, particularly data included in the developer package or data included in the review package, to the safety node 120. The computer program bundle may include at least one computer program executable by the safety node, particularly a safety node computer program, such as, but not limited to, a firmware of the safety node 120. The data may be transferred only under the proviso that a verification of the developer signature, the review signature and/or the review authority signature resulted in verifying the authenticity of e.g. a developer package and/or a review authority package included in the deployment package received by the node device 100. In some embodiments, the computer program bundle may be derived, from the data received by the node device 100, such as a deployment package, e.g. by extracting, decrypting, unpacking or otherwise transforming the data from the deployment package.

As shown in FIG. 1, according to embodiments, the safety node 120 is communicatively connected to the node device 100. In particular, as shown in FIG. 1, the safety node 120 may be a subsystem of the node device 100. Accordingly, the safety node 120 may be communicatively connected to the node device 100 by being communicatively connected to the first processor 110 of the node device 100.

According to embodiments, the safety node 120 is configured for obtaining the computer program bundle from the node device 100. The safety node 120 may further be configured for performing a hashing operation on data included in the computer-readable program product, particularly on data included in the computer program bundle, and a device secret. The hashing operation may be a hashing operation as described with reference to aspects and/or embodiments described herein, particularly a hashing operation suitable for verifying the authenticity of the data, such as the data including a software to be stored on, accessed by, installed on and/or executed on the safety node 120. The developer secret may be known to the developer of the computer program bundle. The developer secret may be identical to a device secret. The developer secret being identical to the device secret may result in an identical challenge hash and verification hash. An identical challenge hash and verification hash may be indicative of the computer program bundle being authentic. The device secret may be known to a manufacturer of the safety node 120. The device secret may be secretly communicated to the developer by the manufacturer, and/or the developer and the device manufacturer may be the same entity. The device secret is stored in a memory of the safety node 120. Hashing the data and the device secret, i.e. hashing the data together with the device secret, results in a verification hash. The safety node 120 is configured for comparing the verification hash with a challenge hash included in the computer-readable program product. The challenge hash may be generated by a creating entity such as a developer by hashing the data and the developer secret. The developer may be a developing entity, such as a human or a group of humans, a deployer, or even an automatic or semi-automatic system.

The challenge hash may be generated, e.g. during development and/or rollout of the computer program bundle, by a creating entity, such as a developer, by performing a hashing operation on the data included in the computer-readable program product, particularly on data included in the computer program bundle. Accordingly, particularly since the hashing operation includes hashing the data and the device secret, and particularly since the hashing operation is performed in the same manner by both the developer and the safety node 120, the hashing operation will only result in a challenge hash being identical to the verification hash if the data is identical to the data generated by a developer, and by a developer utilizing a developer secret identical to the device secret stored in the safety node 120.

According to embodiments, the safety node 120 is configured for comparing the verification hash with the challenge hash included in the computer-readable program product. The safety node 120 is further configured for installing a safety node computer program included in the computer program bundle in a memory of the safety node 120, under the proviso that the challenge hash corresponds to the verification hash. The safety node 120 may be configured for not installing the safety node computer program in cases where comparing the challenge hash and the verification hash indicates that the challenge hash does not correspond to the verification hash.

According to embodiments, the safety node 120 may be one of a type of safety node 120, such as a device type, version and/or generation of safety nodes, which may be industrially produced in large numbers and installed or installable in multiple passenger transport installations. Each safety node of the generation of safety nodes may include the same device secret. Beneficially, the safety node may, e.g. by performing the hashing operation, additionally verify a compatibility of a software, such as a safety node computer program, to be installed on the safety node type.

Additionally, or alternatively, different versions of the safety node 120, production batches, serial number ranges, or even individual safety nodes 120 may be produced with different, e.g. unique, device secrets stored therein. Thus, a computer program bundle may be generated such that it is only installable on a subset of safety nodes 120 having stored, in a memory of the safety node 120, the device secret corresponding to the selected safety nodes 120. This may beneficially reduce the likelihood, severity and/or spread of security breaches, since e.g. a reverse engineering attack to extract the device secret would only potentially allow access to a limited number of devices.

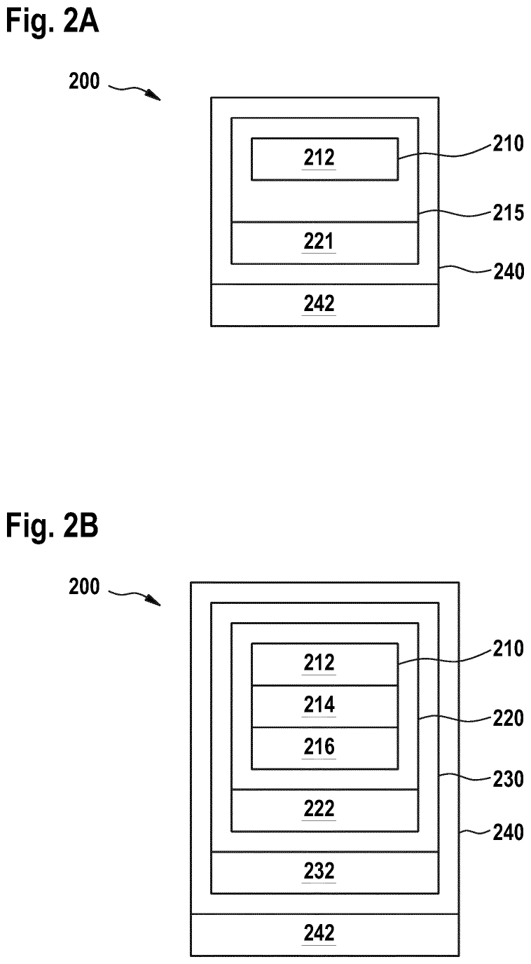

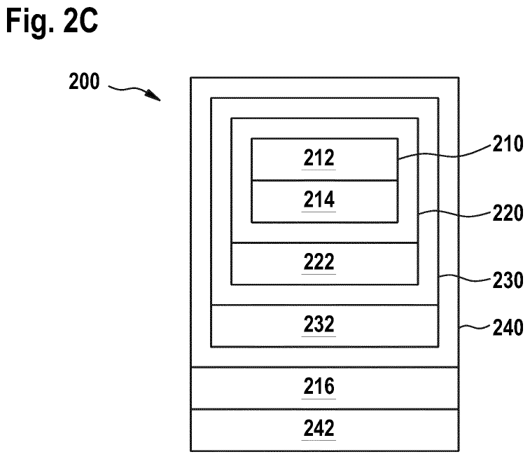

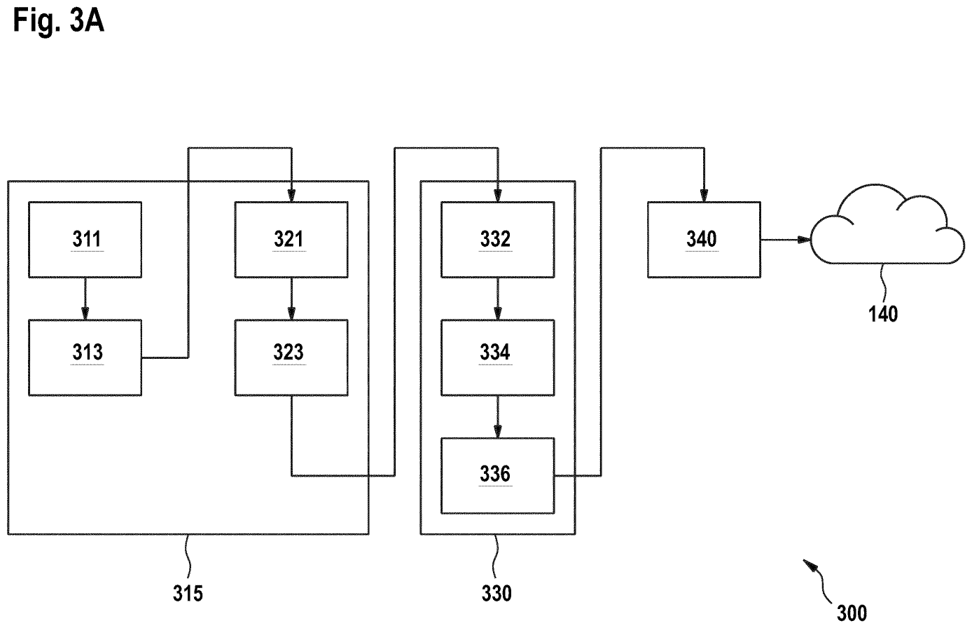

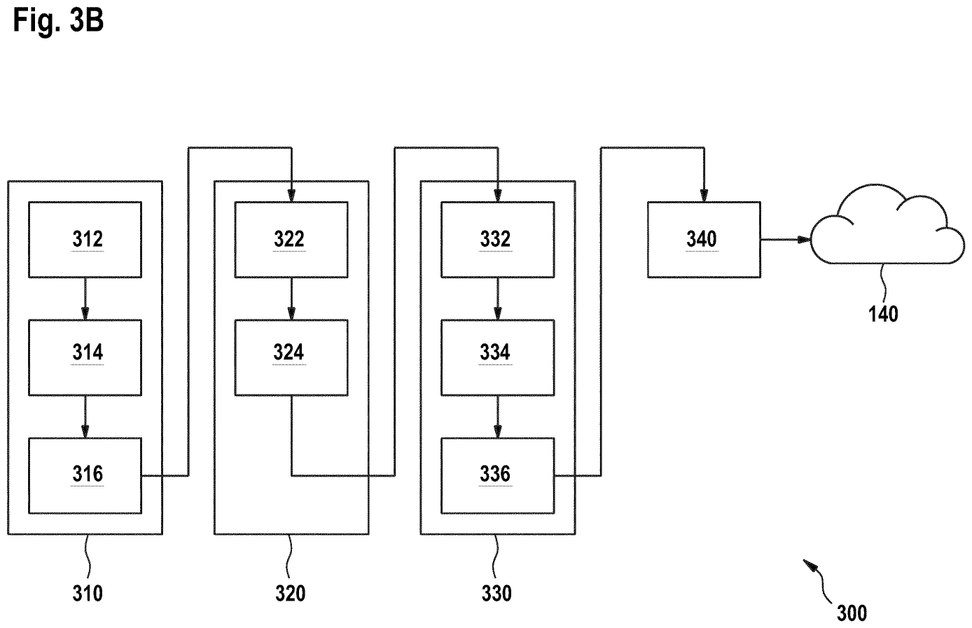

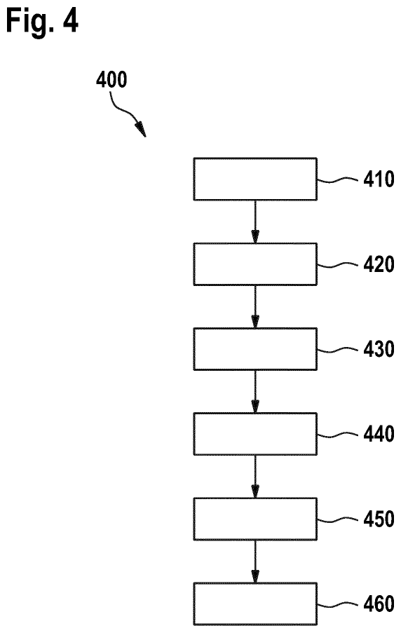

Referring now to FIG. 2A, a computer-readable program product 200 for updating a safety node of a passenger transport installation is described. The safety node may be a safety node 120 as described with reference to FIG. 1. The computer-readable program product 200 may be generated according to a method as described with reference to FIG. 3A. The computer-readable program product may be suitable for a method of obtaining a secure computer program bundle by a passenger transport installation, as described with reference to FIG. 4.

The computer-readable program product 200 includes a deployment package 240. The deployment package 240 includes data including a review package 215, and a deployment signature 242. The deployment signature 242 is a signature of the review package 215 generated with an asymmetric private deployment key. The deployment signature may be a digital signature of data including the review package 215, generated with an asymmetric private deployment key. The authenticity of the deployment package is verifiable by a communication device of the passenger transport installation, such as an edge device 130 as described with reference to FIG. 1. In particular, the communication device may be provided with a public deployment key corresponding to the private deployment key, and be configured for verifying the digital signature with the public deployment key.

According to embodiments, the review package 215 is derivable from the deployment package 240, e.g. by extracting, decrypting, unpacking or otherwise transforming the data from the deployment package 240.

The review package 215 includes data including a computer program bundle 210, and a review signature 221. The review signature 221 is a signature of the computer program bundle 210 generated with an asymmetric private review key. The review signature 221 may be a digital signature of data including the computer program bundle 210, generated with an asymmetric private review key. The authenticity of the review package is verifiable by a communication device of the passenger transport installation, such as an edge device 130 and/or a node device 100 as described with reference to FIG. 1. In particular, the communication device may be provided with a public review key corresponding to the private developer key, and be configured for verifying the digital signature with the public developer key.

According to embodiments, the computer program bundle 210 is derivable from the review package 215, e.g. by extracting, decrypting, unpacking or otherwise transforming the data from the review package 215.

The computer program bundle 210 includes at least one safety node computer program 212. The computer program bundle 210 may include further data and/or a challenge hash, such as the further data 214 and/or the challenge hash 216 described with reference to FIG. 2B.

According to embodiments, the safety node computer program 212 includes a firmware for a safety node of a passenger transport installation. For example, the computer program bundle 210 may be suitable for updating different versions of safety nodes, such as the safety node 120 described with reference to FIG. 1, and may, accordingly, include multiple safety node computer programs suitable for different versions of safety nodes. The safety node computer program 212 is executable by the safety node of the passenger transport installation.

According to embodiments, the computer-readable program product 200 is receivable by a communication device of the passenger transport installation. The communication device may include an edge device, such as the edge device 130 described herein with reference to FIG. 1. The computer-readable program product 200 may further be receivable, fully, or in a processed state, e.g. after having extracted the deployment package, the review authority package, the developer package, and/or the computer program bundle, by further communication devices of the passenger transport installation. Accordingly, further communication devices may include a node device and/or a safety node of the passenger transport installation.

Referring now to FIG. 2B, a computer-readable program product 200 for updating a safety node of a passenger transport installation is described. Aspects of the embodiment shown in FIG. 2B, particularly aspects of the deployment package 240 and/or the computer program bundle 210, may be applicable to the embodiments shown in FIG. 2A and/or FIG. 2C. The safety node may be a safety node 120 as described with reference to FIG. 1. The computer-readable program product 200 may be generated according to a method as described with reference to FIG. 3B. The computer-readable program product may be suitable for a method of obtaining a secure computer program bundle by a passenger transport installation, as described with reference to FIG. 4.

The computer-readable program product 200 includes a deployment package 240. The deployment package 240 includes data including a review authority package 230, and a deployment signature 242. The deployment signature 242 is a signature of the review authority package 230 generated with an asymmetric private deployment key. The deployment signature may be a digital signature of data including the review authority package 230, generated with an asymmetric private deployment key. The authenticity of the deployment package is verifiable by a communication device of the passenger transport installation, such as an edge device 130 as described with reference to FIG. 1. In particular, the communication device may be provided with a public deployment key corresponding to the private deployment key, and be configured for verifying the digital signature with the public deployment key.

According to embodiments, the review authority package 230 is derivable from the deployment package 240, e.g. by extracting, decrypting, unpacking or otherwise transforming the data from the deployment package 240.

The review authority package 230 includes data including a developer package 220, and a review authority signature 232. The review authority signature 232 is a signature of the developer package 220 generated with an asymmetric private review authority key. The review authority signature may be a digital signature of data including the developer package 220, generated with an asymmetric private review authority key. The authenticity of the review authority package is verifiable by a communication device of the passenger transport installation, such as an edge device 130 and/or a node device 100 as described with reference to FIG. 1. In particular, the communication device may be provided with a public review authority key corresponding to the private review authority key, and may be configured for verifying the digital signature with the public review authority key.

According to embodiments, the developer package 220 is derivable from the review authority package 230, e.g. by extracting, decrypting, unpacking or otherwise transforming the data from the review authority package 230.

The developer package 220 includes data including a computer program bundle 210, and a developer signature 222. The developer signature 222 is a signature of the computer program bundle 210 generated with an asymmetric private developer key. The developer signature 222 may be a digital signature of data including the computer program bundle 210, generated with an asymmetric private developer key. The authenticity of the developer package is verifiable by a communication device of the passenger transport installation, such as an edge device 130 and/or a node device 100 as described with reference to FIG. 1. In particular, the communication device may be provided with a public developer key corresponding to the private developer key, and be configured for verifying the digital signature with the public developer key.

According to embodiments, the computer program bundle 210 is derivable from the developer package 220, e.g. by extracting, decrypting, unpacking or otherwise transforming the data from the developer package 220.

The computer program bundle 210 includes at least one safety node computer program 212, and may optionally include further data 214, such as one or more further safety node computer programs. According to embodiments, the safety node computer program 212 includes a firmware for a safety node of a passenger transport installation. For example, the computer program bundle 210 may be suitable for updating different versions of safety nodes, such as the safety node 120 described with reference to FIG. 1, and may, accordingly, include multiple safety node computer programs suitable for different versions of safety nodes. The further data 214 may include data related to the safety node computer program 212, such as non-executable data related to the safety node computer program 212. The safety node computer program 212 is executable by the safety node of the passenger transport installation.

The computer program bundle 210 further includes a challenge hash 216 generated from data including the safety node computer program 212 and a developer secret. The authenticity of the safety node computer program is verifiable by the safety node of the passenger transport installation using a device secret corresponding to the developer secret. When hashed in a hashing operation by a safety node with a device secret identical to the developer secret, and provided that the data is unaltered, the safety node may generate a verification hash that is identical to the challenge hash. This may allow the safety node to verify the authenticity of the data.

According to embodiments, the computer program bundle 210 may include multiple challenge hashes 216. For example, if data included in the same computer program bundle is suitable for several safety nodes having stored thereon different device secrets, a challenge hash corresponding to each device secret may be included. Accordingly, comparing the challenge hash 216 and the verification hash may include comparing the verification hash to multiple challenge hashes.

According to embodiments, the computer-readable program product 200 is receivable by a communication device of the passenger transport installation. The communication device may include an edge device, such as the edge device 130 described herein with reference to FIG. 1. The computer-readable program product 200 may further be receivable, fully, or in a processed state, e.g. after having extracted the deployment package, the review authority package, the developer package, and/or the computer program bundle, by further communication devices of the passenger transport installation. Accordingly, further communication devices may include a node device and/or a safety node of the passenger transport installation.

According to embodiments, the further data 214 may include compatibility manifest data including a compatibility manifest. The compatibility manifest data may be indicative of a compatibility of the safety node computer program with a safety node type. The compatibility manifest may allow determining if the computer program bundle, and/or the at least one safety node computer program 212, and/or one selected from several safety node computer programs included in the computer program bundle 210, is compatible with a safety node having received the computer program bundle 210. By being included in the computer program bundle 210, the compatibility manifest data is included in the deployment package 240. By being included in the computer program bundle 210, the safety node may verify if the safety node is compatible with data, such as a safety node computer program, included in the received computer program bundle 210.

According to embodiments, additionally, or alternatively, the compatibility manifest data may be included in the deployment package 240, e.g. in addition to the deployment signature 242, or any one or more of the review authority package and the developer package. Accordingly, the compatibility manifest may be reviewed by other components than the safety node, such as the edge device and/or the node device.

According to embodiments, the deployment package 240 may include deployment manifest data. The deployment manifest data may include identifiers, such as equipment numbers and/or installation numbers. The identifiers may designate at least one passenger transport installation intended to receive the computer-readable program product, e.g. in order to receive an update. According to embodiments, the identifiers may even designate a selection of one or more safety nodes of a plurality of safety nodes of a passenger installation intended to receive the computer-readable program product, and/or a safety node computer program included in the computer-readable program product. For example, a passenger transport installation may have an assigned identifier, and data representing the identifier may be included in the deployment manifest data. Passenger transport installations, e.g. an edge device of a passenger transport installation, may be configured for only accepting and/or further processing the computer-readable program product if the deployment manifest designates the passenger transport installation the edge device is integrated into. This may beneficially allow a targeted installation of updates for selected passenger transport installations. For example, a maintenance contractor may be responsible for the maintenance of one or more passenger transport installations, and may, e.g. via a deployment system, as a delivery manager, select which passenger transport installations should receive an update. Likewise, the deployment manifest data may include date and time data indicative of when the update is to be installed, which may beneficially allow scheduled updates.

Referring now to FIG. 2C, a further embodiment of a computer-readable program product 200 is described. Only the differences with respect to the computer-readable program product 200 shown in FIG. 2A and FIG. 2B shall be described.

As shown in FIG. 2C, the challenge hash 216 is not included in the computer program bundle 210, but instead is stored in the deployment package 240 in a manner similar to the deployment signature 242 and/or the deployment manifest data. According to embodiments, the deployment signature may be generated based on the review authority package 230 and the challenge hash 216, i.e. the challenge hash 216 may be signed by the deployment signature 242. Likewise, for a computer-readable program product 200 including a review package 215, FIG. 2A, the deployment signature may be generated based on the review package 215. The challenge hash 216 may be generated as described with reference to embodiments described herein, e.g. by a developer and/or a creating entity utilizing one or more developer secret(s) corresponding to one or more device secret(s).

In the embodiment shown in FIG. 2C, the developer package 220 including the developer signature 222, and the review authority package 230 including the review authority signature 232 are generated from the data comprising the safety node computer program 212 and the optional further data 214. This data may be considered static for each version and/or release of the computer program bundle 210, while the challenge hash may change, particularly when the deployment package is to be deployed for different groups of safety nodes having different device secrets. Accordingly, by not generating the developer signature 222 and the review authority signature 232 based on data including the potentially changing challenge hashes 216, the review process may beneficially only be performed once.

Likewise, if desirable, a developer and/or creating entity may generate challenge hashes 216 suitable for authenticating safety nodes having different device secrets, and may independently provide these challenge hashes to a release manager. The release manager may include the desired challenge hashes into the deployment package 240, without having to alter any of the data signed by e.g. a review authority.

Referring now to FIG. 3A, a method 300 of generating a computer-readable program product according to embodiments is described. The computer-readable program product may include data, such as a computer program bundle including a safety node computer program installable on a safety node of a passenger transport installation. The computer-readable program product may be a computer-readable program product 200 as described with reference to FIG. 2A, FIG. 2B and/or FIG. 2C. The method 300 includes performing operations by different entities. The entities include a creating entity 315 and a release manager 330. The creating entity 315 may include a developer, such as a software developer, and a review entity, such as a review authority. The review entity may include a quality control entity, such as a code review entity included in the software development process. The review entity may further include an external review entity, such as a review authority. In a typical scenario, the creating entity 315 may include a software developer, a quality control and testing entity associated with the developer, and an external review authority.

In operation 311, a developer generates one or more computer programs, such as a safety node computer program, to be included in a computer program bundle. The computer program bundle may be a computer program bundle 210 as described with reference to FIG. 2A, FIG. 2B and/or FIG. 2C. Operation 311 may include typical software development operations known in the art, such as, but not limited to, generating code, reviewing the code e.g. during an in-house review, approving a pull request, and/or compiling the code, e.g. to be executed on one or more safety nodes, such as the safety node 120 described with reference to FIG. 1.

According to embodiments, operation 311 may include generating a compatibility manifest, e.g. according to aspects and/or embodiments described herein, and including the compatibility manifest in the computer program bundle.

According to embodiments, in operation 313, a review package is prepared. Preparing the review package may include providing at least one computer program bundle, such as several computer program bundles, and combining the at least one computer program bundle into a prepared review package. Operation 313 may include generating further additional data to be included in the review package, such as data related to version or release control and/or management, and/or package documentation, e.g. according to methods known in the art, such as known methods of managing a release pipeline.

Following operation 313, the prepared review package is made available to be signed by the creating entity 315. In operation 321, a signatory of the creating entity receives the prepared review package and optionally reviews the prepared review package. Reviewing the prepared review package may particularly include verifying and/or validating one or more safety node computer programs, such as firmwares, included in the computer program bundle. Validating the computer program bundle may include validating that safety node computer programs included in the computer program bundle conform to safety requirements of passenger transport installations, and/or certifying the computer program bundle as conforming with safety requirements of passenger transport installations, e.g. according to procedures known in the art.

In operation 323, the prepared review package is signed with a private review key to generate a review package including a review signature, such as the review package 215 described with reference to FIG. 2A. Operation 323 may be performed under the proviso that verification, review and/or validation of the prepared review package was successful.

According to embodiments, either or both operations 321 and 323 may be performed manually, semi-automatic or even fully automatic.

Following operation 323, the review package is made available to a release manager 330. In operation 332, at least one review package, and optionally more than one review packages, is selected by the release manager to be included in a deployment package. The release manager may be an entity other than the creating entity 315. For example, a deployment package may include different safety node computer programs which may be specific for different safety node versions, or even include different safety node computer programs related to different functions, different firmwares, different updates or different safety node types, installable and/or to be installed on different safety nodes of a passenger transport installation. Accordingly, a deployment package may include one or even multiple review packages.

In operation 334, the review signature of the at least one review authority package to be included in the deployment package may be verified by the release manager. Operation 334 may include incorporating one or more challenge hashes into the deployment package, e.g. challenge hashes corresponding to the device secrets of the safety nodes the deployment package is to be delivered to.

In operation 336, the one or more review packages to be included in the deployment package is signed with a private deployment key to generate the deployment package including a deployment signature, such as the deployment package 240 described with reference to FIG. 2A, FIG. 2B and/or FIG. 2C. Operation 336 may be performed under the proviso that verification of the review package(s) was successful.

According to embodiments, either or all operations 332, 334 and/or 336 may be performed manually, semi-automatic or even fully automatic.

Following operation 336, the deployment package is made available to a software deployment system, e.g. by making a computer-readable program product including the deployment package available to be received by a passenger transport installation, e.g. via the data network 140. Optionally, the software deployment system may include operation 340 and/or the software deployment system may allow operation 340 to be performed.

In operation 340, a deployment manifest according to embodiments described herein may be generated, and added to the deployment package. The deployment manifest may be generated by a delivery manager, according to embodiments described herein. Additionally, or alternatively, the deployment manifest may be stored, on the deployment system, outside of the deployment package. The deployment manifest, particularly if added to the deployment package, may be signed, individually or together with further data included in the deployment package, e.g. with the private deployment key.

Following operation 340, a computer-readable program product, including the deployment package and optionally the deployment manifest, may be made available to be received by a passenger transport installation according to data included in the deployment manifest, e.g. via the data network 140.

Referring now to FIG. 3B, a method 300 of generating a computer-readable program product according to further embodiments is described. The computer-readable program product may include data, such as a computer program bundle including a safety node computer program installable on a safety node of a passenger transport installation. The computer-readable program product may be a computer-readable program product 200 as described with reference to FIG. 2A, FIG. 2B and/or FIG. 2C. The method 300 includes performing operations by different entities. The entities include a developer 310, a review authority 320 and a release manager 330.

In operation 312, a developer 310 generates one or more computer programs, such as a safety node computer program, to be included in a computer program bundle. The computer program bundle may be a computer program bundle 210 as described with reference to FIG. 2A, FIG. 2B and/or FIG. 2C. Operation 312 may include typical software development operations known in the art, such as, but not limited to, generating code, reviewing the code e.g. during an in-house review, approving a pull request, and/or compiling the code, e.g. to be executed on one or more safety nodes, such as the safety node 120 described with reference to FIG. 1.

According to embodiments, operation 312 may include generating a compatibility manifest, e.g. according to aspects and/or embodiments described herein, and including the compatibility manifest in the computer program bundle.

In operation 314, data included in the computer program bundle, such as the one or more computer programs and/or the compatibility manifest, is hashed together with a developer secret, corresponding to the device secrets of one or more safety nodes, resulting in a challenge hash, such as the challenge hash 216 described with reference to FIG. 2A, FIG. 2B, and/or FIG. 2C. Operation 314 may likewise be employed in the embodiment discussed with reference to FIG. 3A, such as during operation 313. Operation 314 may be repeated with different developer secrets, resulting in multiple challenge hashes. Including multiple challenge hashes may allow the data to be verified by safety nodes having different device secrets stored therein. Beneficially, the developer secrets and/or device secrets do not require to be shared between the developer and any of the other entities, such as the review authority 320, the release manager 330, or any other entity.

In operation 316, the computer program bundle including the challenge hash(es) is signed with a private developer key to generate a developer package including a developer signature, such as the developer package 220 described with reference to FIG. 2B and/or FIG. 2C. Alternatively, as shown in FIG. 2C, the computer program bundle is signed independently of the challenge hash(es).

According to embodiments, operation 316 may include further generating additional data to be included in the developer package, such as data related to version or release control and/or management, and/or package documentation, e.g. according to methods known in the art, such as known methods of managing a release pipeline.

Following operation 316, the developer package is made available to the review authority 320. The review authority 320 is a different entity than the developer 310, and may, for example, be a certifying organization and/or a government organization. In operation 322 the review authority receives the developer package and reviews the developer package. Reviewing the developer package may include verifying the developer signature, according to embodiments as described herein, to verify the authenticity of the data included in the developer package and/or the computer program bundle. Optionally, if the device secret is known to the review authority 320, the hashing operation may be performed. Beneficially, the authenticity of the developer package may be established by verifying the developer signature alone, and the developer package and/or computer program bundle may be reviewed without performing the hashing operation.

Reviewing the developer package may particularly include verifying and/or validating one or more safety node computer programs, such as firmwares, included in the computer program bundle. Validating the computer program bundle may include validating that safety node computer programs included in the computer program bundle conform to safety requirements of passenger transport installations, and/or certifying the computer program bundle as conforming with safety requirements of passenger transport installations, e.g. according to procedures known in the art.

In operation 324, the developer package is signed with a private review authority key to generate a review authority package including a review authority signature, such as the review authority package 230 described with reference to FIG. 2B and/or FIG. 2C. Operation 324 may be performed under the proviso that verification, review and/or validation of the developer package was successful.

According to embodiments, either or both operations 322 and 324 may be performed manually, semi-automatic or even fully automatic.

Following operation 324, the review authority package is made available to a release manager 330. In operation 332, at least one review authority package, and optionally more than one review authority packages, is selected by the release manager to be included in a deployment package. The release manager may be an entity other than the developer and the review authority. For example, a deployment package may include different safety node computer programs which may be specific for different safety node versions, or even include different safety node computer programs related to different functions, different firmwares, different updates or different safety node types, installable and/or to be installed on different safety nodes of a passenger transport installation. Accordingly, a deployment package may include one or even multiple review authority packages.

In operation 334, the review authority signature of the at least one review authority package to be included in the deployment package may be verified by the release manager. Optionally, operation 334 may include verifying the developer signature, according to embodiments described herein, to verify the authenticity of the data included in the developer package and/or the computer program bundle. Operation 334 may include incorporating one or more challenge hashes into the deployment package, e.g. challenge hashes corresponding to the device secrets of the safety nodes the deployment package is to be delivered to.

In operation 336, the one or more review authority packages to be included in the deployment package is signed with a private deployment key to generate the deployment package including a deployment signature, such as the deployment package 240 described with reference to FIG. 2A, FIG. 2B and/or FIG. 2C. Operation 336 may be performed under the proviso that verification of the review authority package(s) was successful.

According to embodiments, either or all operations 332, 334 and/or 336 may be performed manually, semi-automatic or even fully automatic.

Following operation 336, the deployment package is made available to a software deployment system, e.g. as described with reference to FIG. 3A.

Referring now to FIG. 4, a method 400 of obtaining a secure computer program bundle by a passenger transport installation according to embodiments is described. The passenger transport installation may include the components as described with reference to FIG. 1, particularly a node device 100, a safety node 120, and/or an edge device 130. Obtaining the secure computer program bundle may include obtaining the secure computer program bundle by a safety node of the passenger transport installation. Accordingly, the method 400 may be executable, at least in part, by the system described with reference to FIG. 1.

The method 400 includes obtaining 410 a computer-readable program product. The computer-readable program product may be a computer-readable program product 200 as described with reference to FIG. 2A and/or FIG. 2B, and be obtained by a communication device of the passenger transport installation, such as an edge device, such as the edge device 130 described with reference to FIG. 1, or even a node device, such as the node device 100 described with reference to FIG. 1. The computer-readable program product may be provided by a software deployment system communicatively connected, e.g. via a data network, such as the data network 140, to the communication device of the passenger transport installation.

According to a first embodiment, the computer-readable program product includes a deployment package, a authority package, and the computer program bundle, e.g. according to embodiments described herein. The method 400 may include deriving, e.g. extracting, the deployment package from the computer-readable program product, e.g. by the communication device. The method 400 may include deriving, e.g. extracting, the review package from the deployment package, and/or the computer program bundle from the review package, e.g. by the communication device, such as an edge device or a node device of the passenger transport installation. The method 400 may include deriving, e.g. extracting, a safety node computer program from the computer program bundle, e.g. by the communication device, such as an edge device or a node device, or even a safety node of the passenger transport installation.

According to a second embodiment, the computer-readable program product includes a deployment package, a review authority package, a developer package and the computer program bundle, e.g. according to embodiments described herein. The method 400 may include deriving, e.g. extracting, the deployment package from the computer-readable program product, e.g. by the communication device. The method 400 may include deriving, e.g. extracting, the review authority package from the deployment package, the developer package from the review authority package, and/or the computer program bundle from the developer package, e.g. by the communication device, such as an edge device or a node device of the passenger transport installation. The method 400 may include deriving, e.g. extracting, a safety node computer program from the computer program bundle, e.g. by the communication device, such as an edge device or a node device, or even a safety node of the passenger transport installation.

The method may optionally include obtaining and/or verifying a public deployment key, a public review authority key and a public developer key in operation 420. Likewise, the method may optionally include obtaining and/or verifying a public deployment key and a public review key in operation 420. The public deployment key, the public review authority key, the public review key and/or the public developer key may be obtained by a PKI communicatively connected, e.g. via a data network, to the communication device of the passenger transport installation. In some embodiments, the obtaining and/or verifying of the public deployment key, the public review authority key, the public review key and/or the public developer key from a PKI may be omissible. For example, the public deployment key, the public review authority key, the public review key and/or the public developer key may be provided and/or pre-installed on the communication device, such as the node device and/or the edge device.

The method 400 includes verifying 430 a deployment signature of the deployment package with the public deployment key. The deployment signature may be included in the deployment package, e.g. by generating a deployment package according to aspects and/or embodiments described herein.

According to a first embodiment, the method 400 includes verifying 440 a review signature of the review package with the public review key. The review signature may be included in the review package, e.g. by generating a review package according to aspects and/or embodiments described herein.

According to a second embodiment, the method 400 includes verifying 440 a review authority signature of the review authority package with the public review authority key. The review authority signature may be included in the review authority package, e.g. by generating a review authority package according to aspects and/or embodiments described herein.

The method 400 may include verifying 450 a developer signature of the developer package with the public developer key. The developer signature may be included in the developer package, e.g. by generating a developer package according to aspects and/or embodiments described herein.

The method 400 may include verifying 460 the computer program bundle with a device secret. The device secret may be stored in a memory of the safety node. The device secret may be accessible, during normal operation of the passenger transport installation, only by the safety node. Accordingly, verifying 460 the computer program bundle may be performed by the safety node.

According to embodiments, verifying the deployment signature, the review authority signature, the review signature and/or the developer signature may be understood as verifying data included in the package signed with the signature. Accordingly, verifying the deployment signature, the review authority signature, the review signature and/or the developer signature may further be understood as verifying the integrity of the package signed with the signature.

According to embodiments, verifying 460 the computer program bundle may include performing a hashing operation, such as, but not limited to, a SHA-2-based hashing operation, according to aspects and/or embodiments described herein. In particular, verifying 460 the computer program bundle may include performing a hashing operation on data included in the computer program bundle to generate a verification hash. The hashing operation may include hashing the data and a device secret. Verifying 460 may further include comparing the verification hash with a challenge hash included e.g. in the computer program bundle and/or in the deployment package, e.g. according to aspects and/or embodiments described herein. The hashing operation may hash data included in the computer program bundle, such as one or more safety node computer programs, together with the device secret to generate the verification hash. Verifying 460 the computer program bundle may include only performing further operations, such as installing a safety node computer program on the safety node, under the proviso that the challenge hash is identical to the verification hash, and not performing the further operation if the challenge hash does not match the verification hash.

According to embodiments, the method 400 may include, particularly after having verified 460 the computer program bundle, installing a safety node computer program included in the computer program bundle on a safety node of the passenger transport installation. The safety node computer program may be executable by a processor of the safety node. Installing the safety node computer program may include storing the safety node computer program in a memory of the safety node. Installing the safety node computer program may include updating the safety node, e.g. by replacing a previously installed safety node computer program on the safety node.

According to embodiments, the method 400 may include verifying, particularly before installing a safety node computer program, before verifying 460 the computer program bundle, or even before verifying one or more of the deployment signature, the review authority signature, the review signature and/or the developer signature, a compatibility of the passenger transport installation. Verifying the compatibility may include evaluating a compatibility manifest included in the computer-readable program product, such as e.g. a compatibility manifest included in the review package, the developer package and/or the computer program bundle. For example, a safety node may include data indicative of a compatibility identifier, and the safety node may compare the compatibility identifier with a compatibility identifier included in the compatibility manifest, e.g. before installing the safety node computer program. The method may include not installing the safety node computer program if no matching compatibility identifiers are found between the data included in the safety node and the compatibility manifest.

According to embodiments, installing the safety node computer program may include installing the safety node computer program in a staged and/or staggered manner. For example, a safety node may include multiple channels. Each channel may include a separate processor and/or memory. The multiple channels may be updated in sequence, e.g. in an interlocked sequential operation. This may beneficially allow a first channel to be and/or remain active while a second channel is being updated. The first channel may remain active and perform safety-related tasks, such as monitor the passenger transport installation, while the second channel undergoes the update. Once the second channel has been successfully updated, the second channel may become active, and the first channel, or even a third channel, may be updated.

According to embodiments, the method 400 may include verifying, particularly before installing a safety node computer program, before verifying 460 the computer program bundle, or even before verifying one or more of the deployment signature, the review authority signature, and/or the developer signature, a deployment entitlement of the passenger transport installation. Verifying the deployment entitlement may include evaluating a deployment manifest included in the computer-readable program product, such as e.g. a deployment manifest included in the deployment package. For example, a communication device of the passenger transport installation, such as an edge device, may include data indicative of a passenger transport installation identifier, and the edge device may compare the passenger transport installation identifier with an identifier included in the deployment manifest, e.g. before transferring data included in the deployment package to a node device. The method may include not transferring the data if no matching installation identifiers are found between the data included in the edge device and the deployment manifest.

According to embodiments, a software deployment system is described. The software deployment system may be a computer, such as a server computer, or even a decentralized service, such as a cloud computing solution. The software deployment system may be connected to a data network, such as a data network 140 described with reference to FIG. 1 and FIG. 3A. The software deployment system may be configured for receiving one or more computer-readable program products according to embodiments described herein. The software deployment system may include a data storage device configured for storing the computer-readable program product. The software deployment system may further be configured for providing the computer-readable program product, e.g. by distributing, uploading or otherwise making available, the computer-readable program product, e.g. to passenger transport installations or communication devices of passenger transport installations, according to embodiments described herein.

Benefits of the embodiments described herein include safely updating safety nodes of passenger transport installations without requiring physical access to the safety node. By utilizing several layers of signatures, each entity involved in generating a computer-readable program product may verify the authenticity of the received package, and the passenger transport installation may verify the authenticity of the secure computer program bundle included in the computer-readable program product. Furthermore, the passenger transport installation may verify that a computer program bundle has been generated by a trusted developer, has been reviewed by a trusted review authority, and has been made available by a trusted deployment system. Likewise, the passenger transport installation may verify that the computer program bundle has been generated and signed by a trusted creating entity and has been made available by a trusted deployment system. By generating a verification hash and comparing the verification hash with a challenge hash, a direct line of trust is established between the developer and/or the creating entity and the manufacturer of the safety node and/or the safety node, which may ensure that no alterations to the safety node computer program are possible, even if another layer of security has been breached.

In addition to the foregoing, the following embodiments are described:
Embodiment 1. A method of obtaining a secure computer program bundle by a passenger transport installation, the method comprising:
obtaining a computer-readable program product, the computer-readable program product comprising a deployment package, a review authority package, a developer package and the computer program bundle;
obtaining and/or verifying a public deployment key, a public review authority key and a public developer key;
verifying a deployment signature of the deployment package with the public deployment key;
verifying a review authority signature of the review authority package with the public review authority key;
verifying a developer signature of the developer package with the public developer key; and
verifying the computer program bundle with a device secret.
Embodiment 2. A method of obtaining a secure computer program bundle by a passenger transport installation, the method comprising:
obtaining a computer-readable program product, the computer-readable program product comprising a deployment package, a review package, and the computer program bundle;
obtaining and/or verifying a public deployment key, a public review key and a public developer key;
verifying a deployment signature of the deployment package with the public deployment key;
verifying a review signature of the review package with the public review authority key;
verifying the computer program bundle with a device secret.
Embodiment 3. A computer-readable program product for updating a safety node of a passenger transport installation, comprising:
a deployment package comprising:
   data comprising a review authority package; and
   a deployment signature of the review authority package generated with an asymmetric private deployment key,
the review authority package comprising:
   data comprising a developer package; and
   a review authority signature of the developer package generated with an asymmetric private review authority key, the developer package comprising:
   data comprising a computer program bundle; and
   a developer signature of the computer program bundle generated with an asymmetric private developer key,
the computer program bundle comprising:
   a safety node computer program executable by the safety node of the passenger transport installation; wherein
   the computer-readable program product comprises a challenge hash generated from data comprising the safety node computer program and a developer secret, wherein
   the computer-readable program product is receivable by a communication device of the passenger transport installation, particularly a node device and/or an edge device, and wherein
   the authenticity of the deployment package is verifiable by the communication device of the passenger transport installation using a public deployment key corresponding to the private deployment key,
   the authenticity of the review authority package is verifiable by the communication device of the passenger transport installation using a public review authority key corresponding to the private review authority key, and
   the authenticity of the developer package is verifiable by the communication device of the passenger transport installation using a public developer key corresponding to the private developer key; and wherein
   the authenticity of the safety node computer program is verifiable by the safety node of the passenger transport installation using a device secret corresponding to the developer secret.
Embodiment 4. A computer-readable program product for updating a safety node of a passenger transport installation, comprising:
a deployment package comprising:
   data comprising a review package; and
   a deployment signature of the review package generated with an asymmetric private deployment key,
the review package comprising:
   data comprising a computer program bundle; and
   a review signature of the computer program bundle generated with an asymmetric private review key,
the computer program bundle comprising:
   a safety node computer program executable by the safety node of the passenger transport installation; wherein
   the computer-readable program product comprises a challenge hash generated from data comprising the safety node computer program and a developer secret, wherein
   the computer-readable program product is receivable by a communication device of the passenger transport installation, particularly a node device and/or an edge device, and wherein
   the authenticity of the deployment package is verifiable by the communication device of the passenger transport installation using a public deployment key corresponding to the private deployment key,
   the authenticity of the review package is verifiable by the communication device of the passenger transport installation using a public review key corresponding to the private review key, and
   the authenticity of the safety node computer program is verifiable by the safety node of the passenger transport installation using a device secret corresponding to the developer secret.

In accordance with the provisions of the patent statutes, the present invention has been described in what is considered to represent its preferred embodiment. However, it should be noted that the invention can be practiced otherwise than as specifically illustrated and described without departing from its spirit or scope.

1-21. (canceled)

22. A method of obtaining a secure computer program bundle by a passenger transport installation, the method comprising steps of:
operating a communication device of the passenger transport installation to obtain a computer-readable program product, the program product including a computer program bundle, a review package or a review authority package, and at least one of a developer package and a deployment package;
verifying by the communication device a review signature of the review package with a predetermined public review key when the review package is included in the program product;
verifying by the communication device a review authority signature of the review authority package with a predetermined public review authority key when the review authority package is included in the program product;
verifying by the communication device a developer signature of the developer package with a predetermined public developer key when the developer package is included in the program product;
verifying by the communication device a deployment signature of the deployment package with a predetermined public deployment key when the deployment package is included in the program product; and
authenticating by the communication device that the computer program bundle is secure based upon the verifying of all of the review signature, the review authority signature, the developer signature and the deployment signature that are included in the program product.

23. The method according to claim 22 wherein the authenticating step includes verifying by the communication device the computer program bundle with a device secret.

24. The method according to claim 22 including after performing the authenticating step, installing a safety node computer program in the computer program bundle on a safety node of the passenger transport installation.

25. The method according to claims 22 wherein the authenticating step includes:
performing a hashing operation on data in the computer program bundle to generate a verification hash, wherein the hashing operation includes hashing the data and a device secret, and
comparing the verification hash with a challenge hash to authenticate that the computer program bundle is secure.

26. The method according to claim 22 including verifying a compatibility of the computer program bundle with the passenger transport installation by the communication device evaluating a compatibility manifest included in the program product.

27. A method of generating and installing a computer-readable program product on a safety node of a passenger transport installation, the method comprising steps of:
generating a computer-readable program product including a deployment package;
making the program product available to be received by the passenger transport installation; and
obtaining the program product by the passenger transport installation by performing the method according to claim 22.

28. The method according to claim 27 wherein the program product includes the computer program bundle and the developer package generated by a developer, the review authority package generated by a review authority other than the developer or the review package generated by a creating entity, and the deployment package generated by a release manager other than the developer, the review authority and the creating entity.

29. The method according to claim 27 wherein the deployment package includes data in the review authority package and a deployment signature of the review authority package generated with an asymmetric private deployment key.

30. The method according to claim 27 including generating a deployment manifest that has identifiers, the identifiers designating at least one passenger transport installation intended to receive the program product, and wherein the deployment manifest is generated by a delivery manager.

31. A computer-readable program product for updating a safety node of a passenger transport installation, the program product when stored on a non-transitory computer-readable medium comprising:
a deployment package having data comprising a review package and a deployment signature of the review package or having data comprising a review authority package and a deployment signature of the review authority package;
wherein the review package includes a review signature of data comprising a computer program bundle generated with an asymmetric private review key and the computer program bundle;
wherein the review authority package includes data comprising a developer package and a review authority signature of the developer package generated with an asymmetric private review authority key;
wherein the computer program bundle includes a safety node computer program executable by the safety node of the passenger transport installation;
wherein the developer package includes the computer program bundle and a developer signature of the computer program bundle generated with an asymmetric private developer key; and
wherein the program product is adapted to be received and verified by a communication device of the passenger transport installation, the communication device verifying an authenticity of the deployment package using a public deployment key corresponding to the private deployment key and verifying an authenticity of the review package using a public review key corresponding to the private review key.

32. The program product according to claim 31 including a challenge hash generated from data comprising the safety node computer program and a developer secret.

33. The program product according to claim 32 wherein a safety node of the passenger transport installation verifies an authenticity of the safety node computer program using a device secret corresponding to the developer secret.

34. The program product according to claim 31 wherein the deployment package includes a compatibility manifest data that is indicative of a compatibility of the safety node computer program with a safety node type.

35. The program product according to claim 31 wherein the deployment package includes deployment manifest data that includes identifiers, the identifiers designating at least one passenger transport installation intended to receive the program product.

36. The program product according to claim 31 wherein the safety node computer program is a firmware for a safety node of the passenger transport installation.

37. A passenger transport installation comprising:
a node device;
a safety node communicatively connected to the node device;
an edge device communicatively connected to the node device, the edge device being adapted to communicate with a deployment system to obtain a computer-readable program product from the deployment system;
wherein the edge device is adapted to verify a deployment signature in the program product and transfer data included in the program product to the node device;
wherein the node device is adapted to obtain the data from the edge device after verifying one of a review authority signature and a developer signature included in the data and a review signature included in the data; and
wherein the node device is adapted to transfer to the safety node a computer program bundle in the data obtained from the edge device.

38. The passenger transport installation according to claim 37 wherein the safety node is adapted to perform a hashing operation on the data in the program product to generate a verification hash, wherein the hashing operation includes hashing the data in the program product and a device secret, the device secret being stored in a memory of the safety node, and comparing the verification hash with a challenge hash in the program product, and when the challenge hash corresponds to the verification hash, installing a safety node computer program in the computer program bundle in the memory of the safety node.

39. The passenger transport installation according to claim 38 wherein the hashing operation includes performing a cryptographic hash function.

40. The passenger transport installation according to claim 37 wherein the safety node is included in the node device.

41. The passenger transport installation according to claim 37 wherein the edge device is communicatively connected to a public key infrastructure, the edge device being adapted to obtain from the public key infrastructure at least one of: a public deployment key; a public review authority key; a public review key; and a public developer key.
